(19) United States
(12) Patent Application Publication
(10) Pub. No.: US 2006/0039330 A1
(43) Pub. Date: Feb. 23, 2006

(54) High speed downlink packet access co-processor for upgrading the capabilities of an existing modem host

(75) Inventors: William C. Hackett, Doylestown, PA (US); Robert A. DiFazio, Greenlawn, NY (US); Edward L. Hepler, Malvern, PA (US); Alexander Reznik, Titusville, NJ (US); Douglas R. Castor, Norristown, PA (US); Ariela Zeira, Huntington, NY (US); Robert G. Gazda, Spring City, PA (US); John David Kaewell JR., Jamison, PA (US)

Correspondence Address: VOLPE AND KOENIG, P.C.;DEPT. ICC, UNITED PLAZA, SUITE 1600, 30 SOUTH 17TH STREET, PHILADELPHIA, PA, 19103, US

(73) Assignee: InterDigital Technology Corporation, Wilmington, DE (US)

(21) Appl. No.: 11/184,331

(22) Filed: Jul. 19, 2005

Related U.S. Application Data
(60) Provisional application No. 60/591,005, filed on Jul. 26, 2004.

(51) Int. Cl. H04B 7/216

(52) U.S. Cl. 370/335; 370/437

(57) ABSTRACT

A wireless transmit/receive unit (WTRU) for processing code division multiple access (CDMA) signals. The WTRU includes a modem host and a high speed downlink packet access (HSDPA) co-processor, which communicate over a plurality of customizable interfaces. The modem host operates in accordance with third generation partnership project (3GPP) Release 4 (R4) standards, and the HSDPA co-processor enhances the wireless communication capabilities of the WTRU as a whole such that the WTRU operates in accordance with 3GPP Release 5 (R5) standards.

### CROSS REFERENCE TO RELATED APPLICATION

This application claims the benefit of U.S. Provisional Application No. 60/591,005 filed Jul. 26, 2004, which is incorporated by reference as if fully set forth.

### FIELD OF INVENTION

The present invention relates to the field of wireless communications. More particularly, the present invention relates to a wireless transmit/receive unit (WTRU) including a high speed downlink packet access (HSDPA) co-processor which operates in conjunction with a host chip, such as a modem host in a universal mobile telecommunication system (UMTS) frequency division duplex (FDD) baseband integrated circuit (IC) chip or a dual mode global system for mobile communications (GSM)/general packet radio service (GPRS)/enhanced data rate for GSM evolution (EDGE)/UMTS or GSM/GPRS/UMTS.

### BACKGROUND

HSDPA is a packet-based data service in the UMTS wideband code division multiple access (WCDMA) downlink with a data transmission rate of up to 14 Mbps, over a 5 MHz bandwidth. HSDPA implementations include adaptive modulation and coding (AMC), hybrid automatic repeat request (H-ARQ) and advanced receiver design.

Third Generation Partnership Project (3GPP) specifications are continually being enhanced with new features, designated with parallel “releases.” Release 5 (R5) specifications add HSDPA to provide data rates up to approximately 14 Mbps to support packet-based services, (e.g., multimedia, web-browsing, or the like).

HSDPA is part of FDD R5 and adds some new procedures and physical channels. There are some functions that are normally in the layer 2/3 (L 2/3) protocol stack that have to move down to the physical layer because of latency and timing concerns. There are some stringent timing requirements. For example, there is a positive acknowledgement (ACK)/negative acknowledgement (NACK) signal with a specific transmit time relative to the received data that requires a low latency design.

FDD R5 demands a significant increase in memory requirements primarily because of the volume of data that is being moved around. There are increased signal processing requirements to support quadrature phase shift keying (QPSK), 16 quadrature amplitude modulation (QAM) signaling, and increased bandwidth of the interfaces. Most R4 implementations have been configured to work at approximately 384 Kilobits per second or less. Therefore, to support HSDPA more memory, increased signal processing, and faster interfaces are required. Further, most R4 implementations use a Rake-type receiver. The performance of a Rake receiver (i.e., bit error rate, symbol error rate, and/or net data throughput) can be poor for HSDPA, particularly for the higher categories and higher peak data rates. Hence an improved or advanced receiver is desirable.

### SUMMARY

The present invention is a WTRU (or IC) for processing code division multiple access (CDMA) signals. The WTRU includes a modem host and an HSDPA co-processor, which communicate over a plurality of customizable interfaces. The modem host operates in accordance with 3GPP R4 standards, and the HSDPA co-processor enhances the wireless communication capabilities of the WTRU such that the WTRU operates in accordance with 3GPP R5 standards.

The HSDPA co-processor operates in conjunction with a host chip, such as a modem host in a UMTS FDD baseband IC chip or a dual mode GSM/GPRS/EDGE/UMTS or GSM/GPRS/UMTS IC.

### BRIEF DESCRIPTION OF THE DRAWING

A more detailed understanding of the invention may be had from the following description of a preferred embodiment, given by way of example and to be understood in conjunction with the accompanying drawing wherein:

FIG. 1 illustrates the difference between 3GPP R4 and R5 from a radio frame perspective;

FIG. 2 illustrates a few of the different categories that are defined within the standards;

FIG. 3 is a high level block diagram of a WTRU including an R4 modem host and an HSDPA co-processor that enhances the WTRU such that it exhibits R5 capabilities in accordance with the present invention; and

FIG. 4 is a detailed block diagram of the HSDPA co-processor used in the WTRU of FIG. 3.

### DETAILED DESCRIPTION OF THE PREFERRED EMBODIMENTS

Hereafter, the terminology “WTRU” includes but is not limited to a user equipment (UE), a mobile station, a fixed or mobile subscriber unit, a pager, or any other type of device capable of operating in a wireless environment. When referred to hereafter, the terminology “Node-B” includes but is not limited to a base station, a site controller, an access point or any other type of interfacing device in a wireless environment.

The features of the present invention may be incorporated into at least one IC or be configured in a circuit comprising a multitude of interconnecting components.

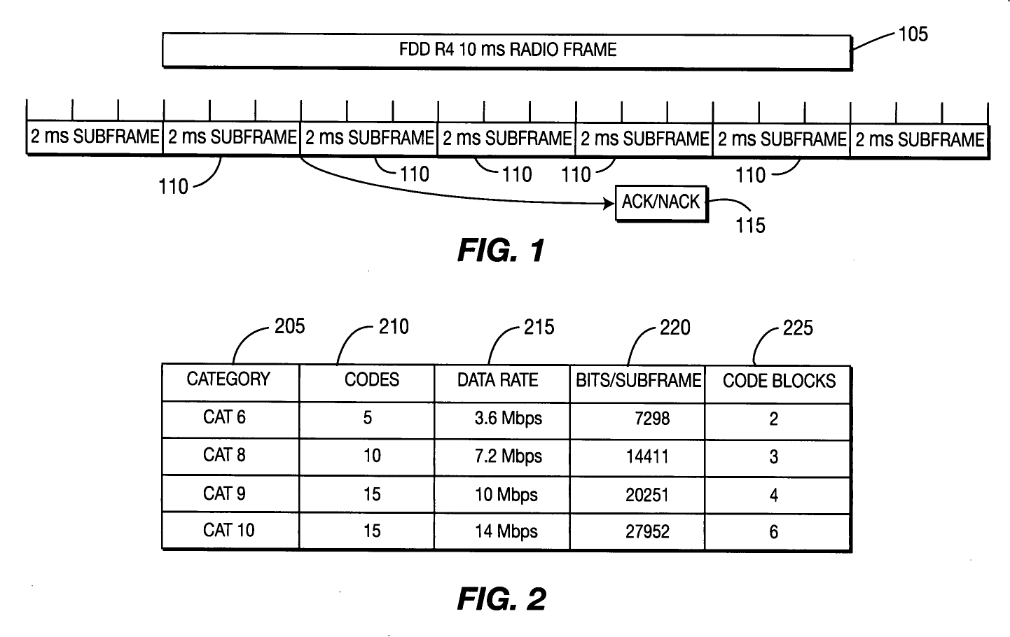

FIG. 1 illustrates the difference between R4 and R5 from a radio frame perspective used for communication between a base station and a WTRU. The FDD R4 traditionally has a ten millisecond (10 ms) radio frame 105. For HSDPA, the radio frame is broken down into five two-millisecond (2 ms) subframes 110. Each subframe 110 is essentially its own little HSDPA transaction. In HSDPA, every time the base station sends a subframe 110 to a WTRU, it expects a response in the form of an ACK/NACK 115 and some CQI information that must be transmitted seven and one-half (7.5) timeslots after the data has arrived at the WTRU.

During each 2 ms subframe 110 in which a WTRU is scheduled to receive data, the data must be received, decoded, checked for integrity, and an ACK/NACK sent back to the base station in the substantially short period of 7.5 timeslots.

FIG. 2 illustrates as an example different HSDPA categories 205 supported by the present invention that are defined within the 3GPP standards TS 25.306, TS 25.211, TS 25.212, TS 25.213 and TS 25.214. It should be understood that the present invention may support other categories that are not illustrated in FIG. 2.

The number of codes 210, data rates 215, bits per subframe 220 and code blocks 225 vary among the different categories 205 that are used during the transmission. For example, Category 6 uses up to 5 codes, a data rate of up to 3.6 Mbps, up to 7298 bits per subframe and up to 2 code blocks. The highest data rate is associated with Category 10 which specifies up to 15 codes, 14 Mbps, 27952 bits per subframe and 6 code blocks.

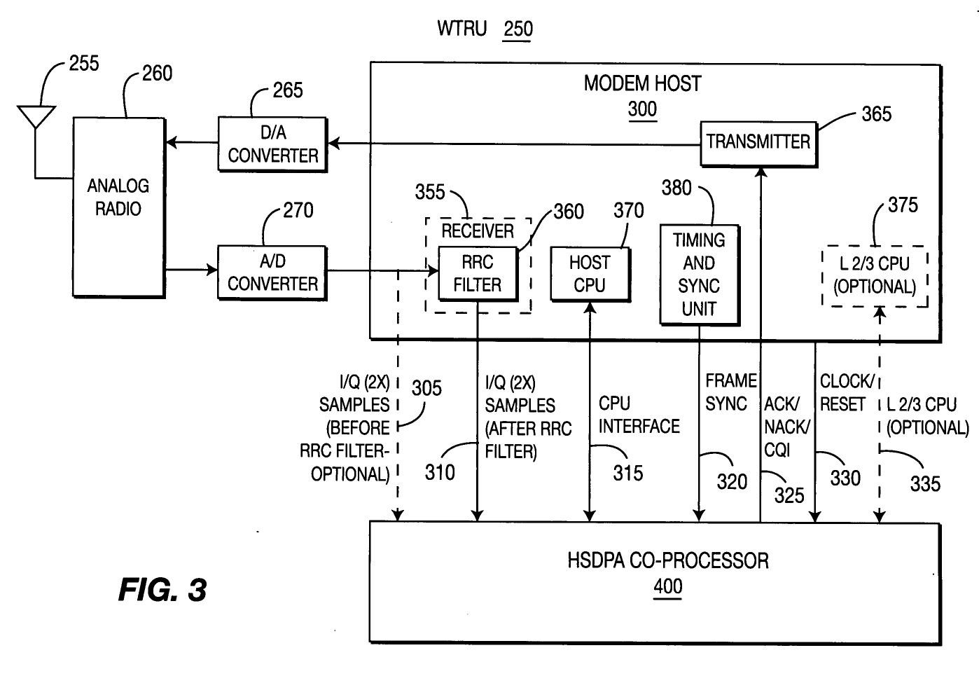

FIG. 3 shows a WTRU 250 including an antenna 255, an analog radio 260, a digital-to-analog (D/A) converter 265, an analog-to-digital (A/D) converter 270, a modem host 300 and an HSDPA co-processor 400. The modem host 300 may be a 3GPP R4 modem host, and the HSDPA co-processor 400 may be a 3GPP R5 HSDPA co-processor. When combined, the modem host 300 and the HSDPA co-processor 400 provide the WTRU 250 with 3GPP R5 capabilities. The modem host 300 may implement the R4 functions and may be capable of stand-alone operation. The HSDPA co-processor 400 interfaces with the modem host 300, and provides the additional functions such that 3GPP FDD R5 requirements are met.

The analog radio 260 supports the transmission and reception of UMTS FDD or dual mode signals by the modem host 300. The HSDPA co-processor 400 supports receiver diversity in which case a dual radio is required along with two antennas. The A/D converter 270 converts received analog baseband signals consisting of HSDPA and other signals to digital samples. The D/A converter 265 converts digital waveforms modulated by the modem host 300 to analog baseband.

In the preferred embodiment, the transmitter and interface to the D/A converter is contained in the modem host. Other embodiments are possible, where a transmitter and/or interface to the D/A converter are contained in the coprocessor. The transmitter in the modem host 300 may be disabled when the HSDPA co-processor 400 is functioning or both the modem host 300 and the HSDPA co-processor 400 may have a transmitter that interface to one or more D/A converters 265 or the analog radio 260.

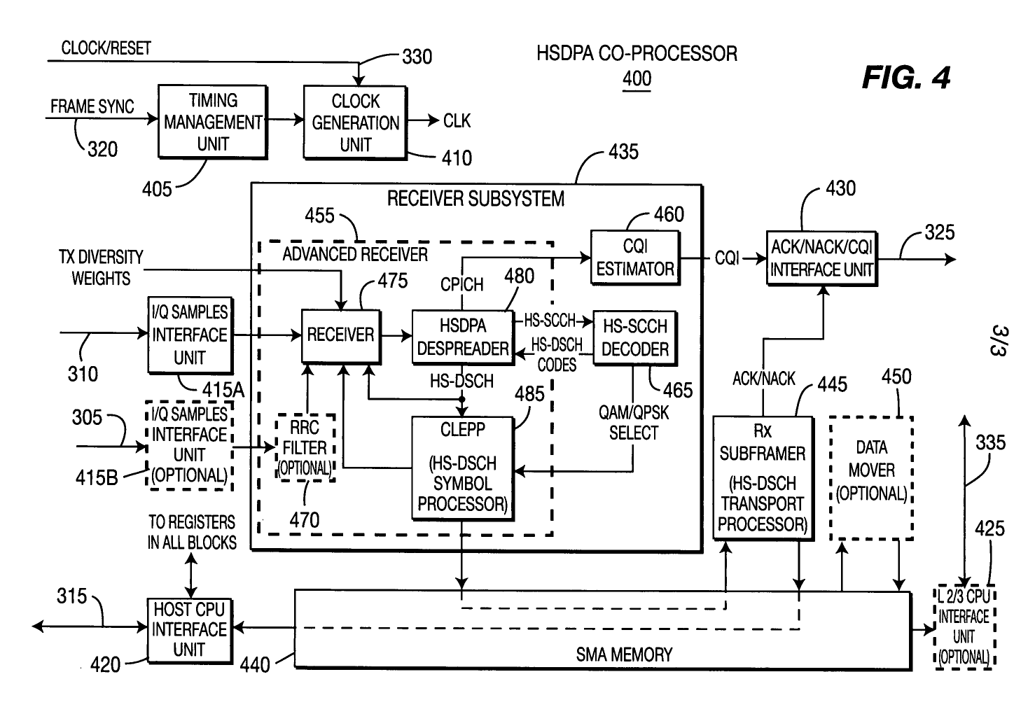

The modem host 300 may include a receiver 355 including a root-raised cosine RRC filter 360. Alternatively, the HSDPA co-processor 400 may optionally include such a filter (see the RRC filter 470 in FIG. 4). The modem host 300 further includes a transmitter 365, a host central processing unit (CPU) 370, an optional layer 2/3 CPU 375 and a timing and sync unit 380.

Referring to FIG. 3, the modem host 300 interfaces with the HSDPA co-processor 400. In a preferred embodiment, the modem host 300 provides eight (8) bit In-phase (I)/Quadrature (Q) samples 310 at twice the WCDMA chip rate (2× sampling) to the HSDPA co-processor 400 via the RRC filter 360 in the receiver 355. Alternatively, six-bit or other word sizes may be used and sampling rates other than 2× may be used. Alternatively, I/Q samples 305 that are obtained before the RRC filter 360 may be provided to the HSDPA co-processor 400 which optionally may have its own RRC filter (see RRC filter 470 in FIG. 4). A CPU interface 315 is established between the HSDPA co-processor 400 and the host CPU 370 in the modem host 300.

A frame sync signal 320 is provided by the timing and sync unit 380 in the modem host 300 to the HSDPA co-processor 400. The HSDPA co-processor 400 provides ACK/NACK/CQI signals to the transmitter 365 of the modem host 300 via an interface 325. The modem host 300 provides a clock/reset signal 330 to the HSDPA co-processor 400. Optionally, an interface 335 is established between the HSDPA co-processor 400 and an optional L 2/3 CPU in the modem host 300.

Referring to FIG. 4, the HSDPA co-processor 400 includes a timing management unit 405 for receiving the frame sync signal 320 from the modem host 300, and a clock generation unit 410 for generating a clock signal for use by the components of the HSDPA co-processor 400 based on the output of the timing management unit 410 and the clock/reset signal 330. The timing management unit 405 provides detailed timing control. The clock signal output by the clock generation unit 410 is derived from the frame sync pulse 320 such that the modem host 300 can keep track of radio frame boundaries, (i.e., the beginning of a radio frame). The clock generation unit 410 provides clock gating for power management. The clock signal has a preferred value that is equal to any multiple of the chip rate. The frame sync is a pulse signifying the start of a 10 ms frame. The HSDPA frame edge may be offset from the frame sync pulse 320 by a programmable offset. The reset interface is an asynchronous pulse. Preferably, the reset interface is an “active low” pulse.

The HSDPA co-processor 400 further includes I/Q samples interface units 415A or 415B for receiving respective I/Q samples 310 or 305. The HSDPA co-processor 400 further includes a host CPU interface unit 420, an optional L 2/3 CPU interface unit 425, an ACK/NACK/CQI interface unit 430, a receiver subsystem 435, a shared memory arbiter (SMA) memory 440, a receiver (Rx) subframer 445 and optionally, a data mover 450 for assisting with ciphering. Thus, the host CPU 370 is able to access registers and the SMA memory 440 in the HSDPA co-processor 400.

The receiver subsystem 435 includes an advanced receiver 455, a CQI estimator 460 and an HS-SCCH decoder 465.

In a preferred embodiment, the advanced receiver 435 includes an optional RRC filter 470, a receiver 475, an HSDPA despreader 480 and a CLE post processor (CLEPP) 485. The receiver 475 may be a normalized least mean square (NLMS) receiver, an NLMS assisted by channel estimation (CE-NLMS) receiver, an NLMS chip level equalizer (CLE) receiver, a CLE (time domain or frequency domain), a Rake receiver, a generalized-Rake (G-Rake) receiver, a receiver that implements other linear or non-linear chip level or symbol level equalizer algorithms, a receiver with a parallel or serial interference canceller, or the like.

The host CPU 370 writes to control registers and control blocks, and accesses information stored in the SMA memory 440 of the HSDPA co-processor 400. The ACK/NACK/CQI interface unit 430 may be a hardware interface or may be a software interface where CQI and ACK/NACK information can be retrieved by the host CPU 370 through reading registers. The amount of time between when the ACK/NACK value is determined and the time that when that ACK/NACK value needs to be transmitted is substantially small and may leave minimal time for a CPU 370 to intervene, hence a hardware interface may be preferable. For higher categories of HSDPA where the number of code blocks 225 can be larger, the processing to determine the ACK/NACK value may be even longer, further decreasing the time available to transfer the ACK/NACK to the modem host 300 and making a hardware interface more desirable.

One of ordinary skill in the art should understand that the interfaces 415A, 415B, 420, 425 and 430 may be configured based on the configuration of the modem host 300 used, and thus the HSDPA co-processor 400 may be customized accordingly.

Referring to the HSDPA co-processor 400 shown in FIG. 4, I/Q samples are received by the receiver 475 of the receiver subsystem 435 via the I/Q samples interface unit 415A or, optionally, the I/Q samples interface unit 415B followed by the RRC filter 470. The receiver 475 extracts chips and provides them to the HSDPA despreader 480. The despreader 480 combines the appropriate number of chips and sends the chips to the CQI estimator 460, the high speed shared control channel (HS-SCCH) decoder 465 and the chip level equalizer post processor (CLEPP) 485. The HS-SCCH decoder 465 decodes that control channel and determines whether the data is applicable to the user of the WTRU 250. If it is, the HS-SCCH decoder 465 sends back the detected control information concerning the high speed downlink shared channel (HS-DSCH) codes, (e.g., the number of codes, channelization codes, or the like), to the HSDPA despreader 480. The HSDPA despreader 480 provides symbols to the CLEPP 485 which performs scaling functions and inputs received symbols into the SMA memory 440. The CQI estimator 460 performs an estimate of the CQI and makes that available for transmission from the WTRU 250 to the base station.

When a subframe of data has been dumped into the SMA memory 440, the Rx subframer 445 performs rate matching, interleaving, turbo decoding, and a cyclic redundancy check (CRC) calculation. The Rx subframer 445 returns the decoded data back into the SMA memory 440 in the form of transport blocks if the CRC calculation passes.

Upon performing the CRC calculation, the Rx subframer 445 either generates either an ACK or a NACK. The ACK/NACK and the CQI are then forwarded to the transmitter 365 in the modem host which sends the ACK/NACK and CQI to the base station via an uplink channel.

In one embodiment, the ACK/NACK/CQI interface unit 430 provides a 3 bit serial interface to the transmitter 365 in the modem host 300. The number of bits provided across the interface depends on where the CQI and ACK/NACK encoding (as specified in the 3GPP standards) is performed. In a preferred embodiment, the encoding is performed in the host CPU 370 (or elsewhere in the modem host 300) and the HSDPA co-processor 400 provides 6 bits for the CQI (1 valid indicator and 5 data bits), and 2 bits for the ACK/NACK/discontinuous transmission (DTX). In another embodiment, the 3GPP specified encoding may be performed in the HSDPA co-processor 400 in which case the CQI is 20 data bits plus 1 valid indicator bit, and the ACK/NACK is 10 bits plus 1 DTX indicator bit. This embodiment requires less processing from the modem host 300 but more bits must be transferred across the interface. Other partitions of the coding may also be implemented. The CQI, ACK/NACK, and the DTX are time critical tasks subject to stringent latency requirements.

The transport blocks saved in the SMA memory 440 are optionally output to the L 2/3 CPU 375 via the L 2/3 CPU interface unit 425. The optional data mover 450 is capable of performing ciphering of the data blocks before placing them back in the SMA memory 440. Background information on the data mover 450 can be found in co-pending patent application Ser. No. 10/878,729 filed on Jun. 28, 2004 entitled “Data-Mover controller with Plural Registers for Supporting Ciphering Operations” by Hepler et al., which is incorporated by reference as if fully set forth herein. High speed medium access control (MAC-hs) re-ordering queues may be optionally allocated in the SMA memory 440.

The HSDPA despreader 480 receives equalized chips from the receiver 475 and despreads the chips into symbols, (spreading factor 16 for high speed physical downlink shared channel (HS-PDSCH), 128 for HS-SCCH). The CQI estimator 460 estimates the channel quality indicator (CQI) based on detection from the common pilot channel (CPICH) channel output by the HSDPA despreader 480. The CQI value is sent to the modem host 300 via the ACK/NACK/CQI interface unit 430. The HS-SCCH decoder 465 receives HS-SCCH (common control channel for HSDPA) symbols from the HSDPA despreader 480 (SF=128) and decodes the symbols via an embedded Viterbi decoder over up to four (4) control channels. Information in these control channels provide QAM/QPSK modulation format to the CLEPP 485.

Detected control information is passed from the CLEPP 485 to the Rx subframer 445 to initiate decoding of the data packet. The CLEPP 485 may provide constellation scaling and de-mapping to produce soft symbols (i.e., bits) for the Rx subframer 445 to decode. The Rx subframer 445 takes output from the CLEPP 485 via the SMA memory 440, and performs physical channel de-mapping, constellation rearrangement (for 16QAM), deinterleaving, bit descrambling, turbo decoding, and CRC calculation, as well as converting soft symbols into hard bits. Decoded transport block data is written to the SMA memory 440. The SMA provides a buffering and communication function between major blocks of the HSDPA co-processor 400. It provides physical channel buffering at the output of the CLEPP 485 from which the input of data to the Rx subframer 445 is read. It also provides buffering of the decoded transport block data from the Rx subframer 445 from which the modem host 300 can read the resulting data block.

In one embodiment, a MAC-hs protocol may be located entirely in the HSDPA co-processor 400. In another embodiment, the MAC-hs is split between the HSDPA co-processor 400 and the Layer 2/3 (L2/3) software running on the L 2/3 CPU 375. For example, the MAC-hs may be distributed among an Incremental Redundancy (IR) buffer, H-ARQ functionality in the HSDPA co-processor 400, and a reordering queue buffer and functionality in the Layer 2/3 software running on the L 2/3 CPU 375.

In the present invention, the functions of the components of the HSDPA co-processor 400 and the modem host 300 described herein may be implemented using hardware, software or a combination thereof. The HSDPA co-processor 400 may be configured as an IC, one or more dies, a separate die that is packaged together with the modem host 300, or a set of technology blocks that may be integrated with the modem host 300 onto a single IC. The interfaces of the modem host 300 may include programmable interrupts which, for example, may be set to trigger at a sub-frame rate or timeslot rate, and a memory mapped interface. Preferably, the memory mapped interface is a 16-bit interface; however, other bit widths may be used.

The preferred embodiment of the HSDPA co-processor 400 requires that the modem host 300 provides the location of the first significant path (FSP) of the multipath from the HSDPA serving cell. Those skilled in the art know that a received signal is often spread in time due to multipath in the communication channel. The FSP information is used to position the processing window of the advanced receiver 455 around the received energy.

The FSP information may be provided as a timing offset relative to the frame sync timing via the CPU interface 315. In one embodiment, a hardware interface may be used and/or the FSP location may be provided relative to a different time reference known to both the modem host 300 and the HSDPA co-processor 400. In another embodiment, the modem host 300 may supply a list of multipath terms that includes the position in time of each term rather than just the FSP. In yet another embodiment, when the modem host 300 is unable to provide the required FSP information, the receiver subsystem may include circuitry and/or software to locate and track the FSP and other multipath parameters.

In the preferred embodiment, the modem host 300 signals HSDPA related information and some general system information from RRC messages that is required by the HSDPA co-processor 400. Some of the signaled parameters include scrambling codes, the number of HS-SCCHs and their codes, H-ARQ memory sizes, and compressed mode parameters.

The hardware and/or software interfaces may include a means for the modem host 300 to power-down the HSDPA co-processor 400 or place it in a low-power standby mode. This would prolong battery life during periods of time when the HSDPA processing is not required.

Although the features and elements of the present invention are described in the preferred embodiments in particular combinations, each feature or element can be used alone without the other features and elements of the preferred embodiments or in various combinations with or without other features and elements of the present invention.

What is claimed is:

1. A wireless transmit/receive unit (WTRU) for processing code division multiple access (CDMA) signals, the WTRU comprising:
(a) a modem host; and
(b) a high speed downlink packet access (HSDPA) co-processor in communication with the modem host over a plurality of customizable interfaces, wherein the HSDPA co-processor enhances the wireless communication capabilities of the WTRU beyond those capabilities provided by the modem host alone.

2. The WTRU of claim 1 wherein the modem host operates in accordance with third generation partnership project (3GPP) Release 4 (R4) standards, and the HSDPA co-processor enhances the wireless communication capabilities of the WTRU such that the WTRU operates in accordance with 3GPP Release 5 (R5) standards.

3. The WTRU of claim 1 wherein the modem host includes a receiver including a root-raised cosine (RRC) filter.

4. The WTRU of claim 3 wherein the HSDPA co-processor includes an in-phase (I)/quadrature (Q) samples interface for receiving I/Q samples from an output of the RRC filter in the modem host.

5. The WTRU of claim 4 wherein the I/Q samples are provided by the RRC filter in the modem host to the I/Q samples interface of the HSDPA co-processor at a rate that is substantially twice the chip rate of the CDMA signals.

6. The WTRU of claim 1 wherein the HSDPA co-processor includes a receiver including a root-raised cosine (RRC) filter.

7. The WTRU of claim 6 wherein the HSDPA co-processor includes an in-phase (I)/quadrature (Q) samples interface for receiving I/Q samples from the modem host and providing the I/Q samples to an input of the RRC filter in the receiver of the HSDPA co-processor.

8. The WTRU of claim 7 wherein the I/Q samples are provided to the I/Q samples interface of the HSDPA co-processor at a rate that is substantially twice the chip rate of the CDMA signals.

9. The WTRU of claim 1 wherein the modem host includes a host central processing unit (CPU), and the HSDPA co-processor includes a host CPU interface for establishing communications between the host CPU and the HSDPA co-processor.

10. The WTRU of claim 1 wherein the modem host includes a timing and sync unit, and the HSDPA co-processor includes a timing management unit for receiving a frame sync pulse from the timing and sync unit of the modem host.

11. The WTRU of claim 10 wherein the HSDPA co-processor includes a clock generation unit in communication with the timing management unit, the clock generation unit for receiving a clock/reset signal from the modem host and generating a signal based on the frame sync pulse and the clock/reset signal.

12. The WTRU of claim 1 wherein the modem host includes a transmitter, and the HSDPA co-processor provides channel quality indicators (CQIs) and acknowledge (ACK)/non-acknowledge (NACK) signals to the transmitter in the modem host.

13. The WTRU of claim 1 wherein the modem host includes a layer 2/3 central processing unit (CPU), and the HSDPA co-processor includes a layer 2/3 CPU interface for communicating with the layer 2/3 CPU in the modem host.

14. The WTRU of claim 1 wherein the modem host comprises a means for powering-down the HSDPA co-processor or placing the co-processor in a low-power standby mode when HSDPA processing is not required.

15. A high speed downlink packet access (HSDPA) co-processor for enhancing the capabilities of a modem host in a wireless transmit/receive unit (WTRU), the HSDPA co-processor comprising:
(a) a receiver subsystem;
(b) a shared memory arbiter (SMA) memory in communication with the receiver subsystem;
(c) at least one interface for communicating with the modem host; and
(d) a receiver subframer in communication with the SMA memory.

16. The HSDPA co-processor of claim 15 wherein the receiver subsystem includes:
(a1) a root-raised cosine (RRC) filter;
(a2) a normalized least mean square (NLMS) chip level equalizer (CLE) receiver for receiving in-phase (I)/quadrature (Q) samples from the RRC filter;
(a3) an HSDPA despreader in communication with an output of the NLMS CLE receiver;
(a4) a chip level equalizer post processor (CLEPP) in communication with the NLMS CLE receiver and the HSDPA despreader;
(a5) a high speed shared control channel (HS-SCCH) decoder in communication with the HSDPA despreader and the CLEPP; and
(a6) a channel quality indicator (CQI) estimator in communication with the HSDPA despreader for providing CQI information to the modem host.

17. The HSDPA co-processor of claim 16 further comprising:
(e) a data mover in communication with the SMA memory.

18. The HSDPA co-processor of claim 15 wherein the receiver subsystem includes:
(a1) a root-raised cosine (RRC) filter;
(a2) a Rake receiver for receiving in-phase (I)/quadrature (Q) samples from the RRC filter;
(a3) an HSDPA despreader in communication with an output of the Rake receiver;
(a4) a chip level equalizer post processor (CLEPP) in communication with the Rake receiver and the HSDPA despreader;
(a5) a high speed shared control channel (HS-SCCH) decoder in communication with the HSDPA despreader and the CLEPP; and
(a6) a channel quality indicator (CQI) estimator in communication with the HSDPA despreader for providing CQI information to the modem host.

19. The HSDPA co-processor of claim 18 further comprising:
(e) a data mover in communication with the SMA memory.

20. A wireless transmit/receive unit (WTRU) comprising:
(a) a modem host which operates in accordance with third generation partnership project (3GPP) Release 4 (R4) standards; and
(b) a high speed downlink packet access (HSDPA) co-processor for upgrading the wireless communication capabilities of the WTRU such that the WTRU operates in accordance with 3GPP Release 5 (R5) standards.

21. An integrated circuit (IC) for processing code division multiple access (CDMA) signals, the IC comprising:
(a) a modem host; and
(b) a high speed downlink packet access (HSDPA) co-processor in communication with the modem host over a plurality of customizable interfaces, wherein the HSDPA co-processor enhances the wireless communication capabilities of the IC beyond those capabilities provided by the modem host alone.

22. The IC of claim 21 wherein the modem host operates in accordance with third generation partnership project (3GPP) Release 4 (R4) standards, and the HSDPA co-processor enhances the wireless communication capabilities of the IC such that the IC operates in accordance with 3GPP Release 5 (R5) standards.

23. The IC of claim 21 wherein the modem host includes a receiver including a root-raised cosine (RRC) filter.

24. The IC of claim 23 wherein the HSDPA co-processor includes an in-phase (I)/quadrature (Q) samples interface for receiving I/Q samples from an output of the RRC filter in the modem host.

25. The IC of claim 24 wherein the I/Q samples are provided by the RRC filter in the modem host to the I/Q samples interface of the HSDPA co-processor at a rate that is substantially twice the chip rate of the CDMA signals.

26. The IC of claim 21 wherein the HSDPA co-processor includes a receiver including a root-raised cosine (RRC) filter.

27. The IC of claim 26 wherein the HSDPA co-processor includes an in-phase (I)/quadrature (Q) samples interface for receiving I/Q samples from the modem host and providing the I/Q samples to an input of the RRC filter in the receiver of the HSDPA co-processor.

28. The IC of claim 27 wherein the I/Q samples are provided to the I/Q samples interface of the HSDPA co-processor at a rate that is substantially twice the chip rate of the CDMA signals.

29. The IC of claim 21 wherein the modem host includes a host central processing unit (CPU), and the HSDPA co-processor includes a host CPU interface for establishing communications between the host CPU and the HSDPA co-processor.

30. The IC of claim 21 wherein the modem host includes a timing and sync unit, and the HSDPA co-processor includes a timing management unit for receiving a frame sync pulse from the timing and sync unit of the modem host.

31. The IC of claim 30 wherein the HSDPA co-processor includes a clock generation unit in communication with the timing management unit, the clock generation unit for receiving a clock/reset signal from the modem host and generating a signal based on the frame sync pulse and the clock/reset signal.

32. The IC of claim 21 wherein the modem host includes a transmitter, and the HSDPA co-processor provides channel quality indicators (CQIs) and acknowledge (ACK)/non-acknowledge (NACK) signals to the transmitter in the modem host.

33. The IC of claim 21 wherein the modem host includes a layer 2/3 central processing unit (CPU), and the HSDPA co-processor includes a layer 2/3 CPU interface for communicating with the layer 2/3 CPU in the modem host.

34. The IC of claim 21 wherein the modem host comprises a means for powering-down the HSDPA co-processor or placing the co-processor in a low-power standby mode when HSDPA processing is not required.

35. An integrated circuit (IC) for enhancing the capabilities of a modem host in a wireless transmit/receive unit (WTRU), the IC comprising:
(a) a receiver subsystem;
(b) a shared memory arbiter (SMA) memory in communication with the receiver subsystem;
(c) at least one interface for communicating with the modem host; and
(d) a receiver subframer in communication with the SMA memory.

36. The IC of claim 35 wherein the receiver subsystem includes:
(a1) a root-raised cosine (RRC) filter;
(a2) a normalized least mean square (NLMS) CLE receiver for receiving in-phase (I)/quadrature (Q) samples from the RRC filter;
(a3) an HSDPA despreader in communication with an output of the NLMS CLE receiver;
(a4) a chip level equalizer post processor (CLEPP) in communication with the NLMS CLE receiver and the HSDPA despreader;
(a5) a high speed shared control channel (HS-SCCH) decoder in communication with the HSDPA despreader and the CLEPP; and
(a6) a channel quality indicator (CQI) estimator in communication with the HSDPA despreader for providing CQI information to the modem host.

37. The IC of claim 36 further comprising:
(e) a data mover in communication with the SMA memory.

38. The IC of claim 35 wherein the receiver subsystem includes:
(a1) a root-raised cosine (RRC) filter;
(a2) a Rake receiver for receiving in-phase (I)/quadrature (Q) samples from the RRC filter;
(a3) an HSDPA despreader in communication with an output of the Rake receiver;
(a4) a chip level equalizer post processor (CLEPP) in communication with the Rake receiver and the HSDPA despreader;
(a5) a high speed shared control channel (HS-SCCH) decoder in communication with the HSDPA despreader and the CLEPP; and
(a6) a channel quality indicator (CQI) estimator in communication with the HSDPA despreader for providing CQI information to the modem host.

39. The IC of claim 38 further comprising:
(e) a data mover in communication with the SMA memory.

40. An integrated circuit (IC) comprising:
(a) a modem host which operates in accordance with third generation partnership project (3GPP) Release 4 (R4) standards; and
(b) a high speed downlink packet access (HSDPA) co-processor for upgrading the wireless communication capabilities of the IC such that the IC operates in accordance with 3PP Release 5 (R5) standards.

41. A high speed downlink packet access (HSDPA) co-processor for enhancing the capabilities of a modem host in a wireless transmit/receive unit (WTRU), the HSDPA co-processor comprising:
(a) a normalized least mean square (NLMS) chip level equalizer (CLE) receiver for receiving in-phase (I)/quadrature (Q) samples;
(b) an HSDPA despreader in communication with an output of the NLMS CLE receiver;
(c) a chip level equalizer post processor (CLEPP) in communication with the NLMS CLE receiver and the HSDPA despreader;
(d) a high speed shared control channel (HS-SCCH) decoder in communication with the HSDPA despreader and the CLEPP; and
(e) a channel quality indicator (CQI) estimator in communication with the HSDPA despreader for providing CQI information to the modem host.

42. A high speed downlink packet access (HSDPA) co-processor for enhancing the capabilities of a modem host in a wireless transmit/receive unit (WTRU), the HSDPA co-processor comprising:
(a) a Rake receiver for receiving in-phase (I)/quadrature (Q) samples;
(b) an HSDPA despreader in communication with an output of the Rake receiver;
(c) a chip level equalizer post processor (CLEPP) in communication with the Rake receiver and the HSDPA despreader;
(d) a high speed shared control channel (HS-SCCH) decoder in communication with the HSDPA despreader and the CLEPP; and
(e) a channel quality indicator (CQI) estimator in communication with the HSDPA despreader for providing CQI information to the modem host.

43. An integrated circuit (IC) for enhancing the capabilities of a modem host in a wireless transmit/receive unit (WTRU), the IC comprising:
(a) a normalized least mean square (NLMS) chip level equalizer (CLE) receiver for receiving in-phase (I)/quadrature (Q) samples;
(b) a high speed downlink packet access (HSDPA) despreader in communication with an output of the NLMS CLE receiver;
(c) a chip level equalizer post processor (CLEPP) in communication with the NLMS CLE receiver and the HSDPA despreader;
(d) a high speed shared control channel (HS-SCCH) decoder in communication with the HSDPA despreader and the CLEPP; and
(e) a channel quality indicator (CQI) estimator in communication with the HSDPA despreader for providing CQI information to the modem host.

44. An integrated circuit (IC) for enhancing the capabilities of a modem host in a wireless transmit/receive unit (WTRU), the IC comprising:
(a) a Rake receiver for receiving in-phase (I)/quadrature (Q) samples;
(b) a high speed downlink packet access (HSDPA) despreader in communication with an output of the Rake receiver;
(c) a chip level equalizer post processor (CLEPP) in communication with the Rake receiver and the HSDPA despreader;
(d) a high speed shared control channel (HS-SCCH) decoder in communication with the HSDPA despreader and the CLEPP; and
(e) a channel quality indicator (CQI) estimator in communication with the HSDPA despreader for providing CQI information to the modem host.
